(19) United States
(12) Patent Application Publication
(10) Pub. No.: US 2016/0180039 A1
(43) Pub. Date: Jun. 23, 2016

(54) MANAGING NEWBORN SCREENING RESULTS

(71) Applicant: CERNER INNOVATION, INC., Kansas City, KS (US)

(72) Inventor: JOSH HAYES, KANSAS CITY, MO (US)

(21) Appl. No.: 14/579,346

(22) Filed: Dec. 22, 2014

(51) Int. Cl. G06F 19/00

(52) U.S. Cl. CPC G06F 19/345; G06F 19/322; G06F 19/366

(57) ABSTRACT

Methods, systems, and computer-readable media are provided for managing newborn screening results. A screening manager may be provided to receive, store, communicate, and evaluate newborn screening results. The screening manager may evaluate the newborn screening results in view of several factors including a genetic screening standard of care, a family history of a patient associated with the newborn screening result, etc. Based on the comparison, a recommendation may be provided to a clinician. The recommendation may include a diagnosis, a treatment plan, follow-up instructions, etc. The screening manager may also update the patient's electronic health record with both the newborn screening result and the recommendation.

### BACKGROUND

Many newborns die or are seriously debilitated each year from diseases and disorders that can be easily detected and treated before any severe, long-term damage occurs. Early detection and communication of critical results indicating the presence of such a disorder are vital to ensure timely treatment is provided to prevent any detrimental effects. Accordingly, each state attempts to test every newborn for a panel of disorders determined by the state. In addition, a number of private laboratories provide expanded screening for a variety of additional disorders. Generally, newborn screening currently entails collecting a blood sample from a newborn shortly after birth. The blood sample is then sent to a state laboratory and/or an independent laboratory for testing. The laboratory performs the testing and sends the results to any indicated recipient, such as a pediatrician for the newborn or the hospital that served as the place of birth.

Although current newborn screening programs provide substantial benefit in detecting disorders and saving newborn lives, there remains a deficit. While there has been an increase in electronic record organization, it does not alleviate the lack of exposure to rare disorders identified in newborn screenings. Some of the disorders are life-threatening and require immediate action. If clinicians are not exposed to the disorders or trained on how to deal with them, the appropriate actions may not be readily apparent to a clinician or acted upon quickly. Put simply, there is no clinical decision support to aid clinicians in managing newborn screening results.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

In brief and at a high level, this disclosure describes, among other things, methods, systems, and computer-readable media for managing newborn screening results. Newborn screening results may be evaluated in view of a plurality of criteria including genetic screening standards of care, family history, evidence based recommendations, and the like. Based on the evaluation and comparison with one or more criteria, a recommendation may be generated to aid a clinician in managing newborn screening results. The recommendation may include a diagnosis, a treatment plan, a follow-up recommendation, or the like.

### BRIEF DESCRIPTION OF THE DRAWINGS

Embodiments are described in detail below with reference to the attached drawings figures, wherein:

FIG. 1 is a block diagram of an exemplary computing system suitable to implement embodiments of the present invention;

FIG. 2 is a diagram of an exemplary system architecture suitable to implement embodiments of the present invention;

FIG. 3 is a flow diagram showing a method for managing newborn screening results in accordance with an embodiment of the present invention;

FIG. 4 is a flow diagram showing a method for managing newborn screening results in accordance with embodiments of the present invention;

FIG. 5 depicts an exemplary graphical user interface (GUI) for managing newborn screening results in accordance with embodiments of the present invention;

FIG. 6 depicts an exemplary GUI for managing newborn screening results in accordance with embodiments of the present invention;

FIG. 7 depicts an exemplary GUI for managing newborn screening results in accordance with embodiments of the present invention;

FIG. 8 depicts an exemplary GUI for managing newborn screening results in accordance with embodiments of the present invention;

FIG. 9 depicts an exemplary GUI for managing newborn screening results in accordance with embodiments of the present invention;

FIG. 10 depicts an exemplary GUI for managing newborn screening results in accordance with embodiments of the present invention; and

FIG. 11 depicts an exemplary GUI for managing newborn screening results in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to methods, systems, and computer-readable media for managing newborn screening results. Newborn screening results may be evaluated in view of a plurality of criteria including genetic screening standards of care, family history, evidence based recommendations, and the like. Based on the evaluation and comparison with one or more criteria, a recommendation may be generated to aid a clinician in managing newborn screening results. The recommendation may include a diagnosis, a treatment plan, a follow-up recommendation, or the like.

A first aspect is directed to a computerized method, carried out by at least one server having one or more processors. The method includes, in part, receiving a newborn screening result for a patient; comparing the newborn screening result with at least a genetic screening standard of care; based on the comparison, generating a recommendation; and providing the recommendation.

A second aspect is directed to a system for managing newborn screening results. The system includes one or more processors and one or more computer storage media storing computer-useable instructions that, when used by the one or more processors, causes the one or more processors to: receive a newborn screening result for a patient; compare the newborn screening result with at least a genetic screening standard of care; based on the comparison, generate a recommendation; and provide the recommendation.

A third aspect is directed to one or more computer storage media having computer-executable instructions embodied thereon that, when executed, facilitate a method of managing newborn screening results. The media includes receiving an order for a newborn screening of a patient; receiving a newborn screening result for the patient; comparing the newborn screening result with at least a genetic screening standard of care and a family history of the patient; based on the comparison, generating a recommendation including follow-up instructions; providing the recommendation; and updating the patient's electronic health record with the newborn screening result and the recommendation.

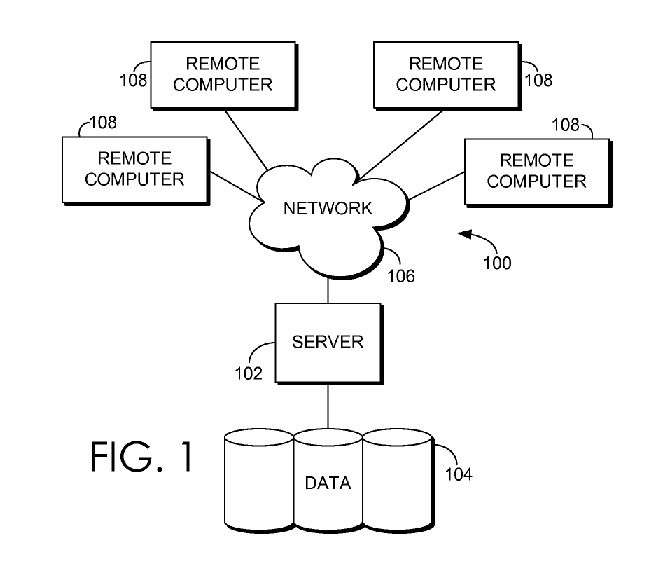

Referring to the drawings in general, and initially to FIG. 1 in particular, an exemplary computing system environment, for instance, a medical information computing system, on which embodiments of the present invention may be implemented is illustrated and designated generally as reference numeral 100. It will be understood and appreciated by those of ordinary skill in the art that the illustrated medical information computing system environment 100 is merely an example of one suitable computing environment and is not intended to suggest any limitation as to the scope of use or functionality of the invention. Neither should the medical information computing system environment 100 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 100 includes a general purpose computing device in the form of a server 102. Components of the server 102 may include, without limitation, a processing unit, internal system memory, and a suitable system bus for coupling various system components, including database cluster 104, with the server 102. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 102 typically includes, or has access to, a variety of computer readable media, for instance, database cluster 104. Computer-readable media can be any available media that may be accessed by server 102, and includes volatile and nonvolatile media, as well as removable and non-removable media. By way of example, and not limitation, computer readable media may include computer storage media and communication media. Computer storage media may include, without limitation, volatile and nonvolatile media, as well as removable and non-removable media implemented in any method or technology for storage of information, such as computer-readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 102. Computer storage media does not comprise signals per se. Communication media typically embodies computer-readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

The computer storage media discussed above and illustrated in FIG. 1, including database cluster 104, provide storage of computer-readable instructions, data structures, program modules, and other data for the server 102.

The server 102 may operate in a computer network 106 using logical connections to one or more remote computers 108. Remote computers 108 may be located at a variety of locations in a medical or research environment, for example, but not limited to, clinical laboratories, hospitals and other inpatient settings, veterinary environments, ambulatory settings, medical billing and financial offices, hospital administration settings, home health-care environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, veterinarians, students, and the like. The remote computers 108 may also be physically located in non-traditional medical care environments so that the entire health care community may be capable of integration on the network. The remote computers 108 may be personal computers, servers, routers, network PCs, peer devices, other common network nodes, or the like, and may include some or all of the components described above in relation to the server 102. The devices can be personal digital assistants or other like devices.

Exemplary computer networks 106 may include, without limitation, local area networks (LANs) and/or wide area networks (WANs). Such networking environments are commonplace in offices, enterprise-wide computer networks, intranets, and the Internet. When utilized in a WAN networking environment, the server 102 may include a modem or other means for establishing communications over the WAN, such as the Internet. In a networked environment, program modules or portions thereof may be stored in the server 102, in the database cluster 104, or on any of the remote computers 108. For example, and not by way of limitation, various application programs may reside on the memory associated with any one or more of the remote computers 108. It will be appreciated by those of ordinary skill in the art that the network connections shown are exemplary and other means of establishing a communications link between the computers (e.g., server 102 and remote computers 108) may be utilized.

In operation, a user may enter commands and information into the server 102 or convey the commands and information to the server 102 via one or more of the remote computers 108 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 102. In addition to a monitor, the server 102 and/or remote computers 108 may include other peripheral output devices, such as speakers and a printer.

Although many other internal components of the server 102 and the remote computers 108 are not shown, those of ordinary skill in the art will appreciate that such components and their interconnection are well known. Accordingly, additional details concerning the internal construction of the server 102 and the remote computers 108 are not further disclosed herein.

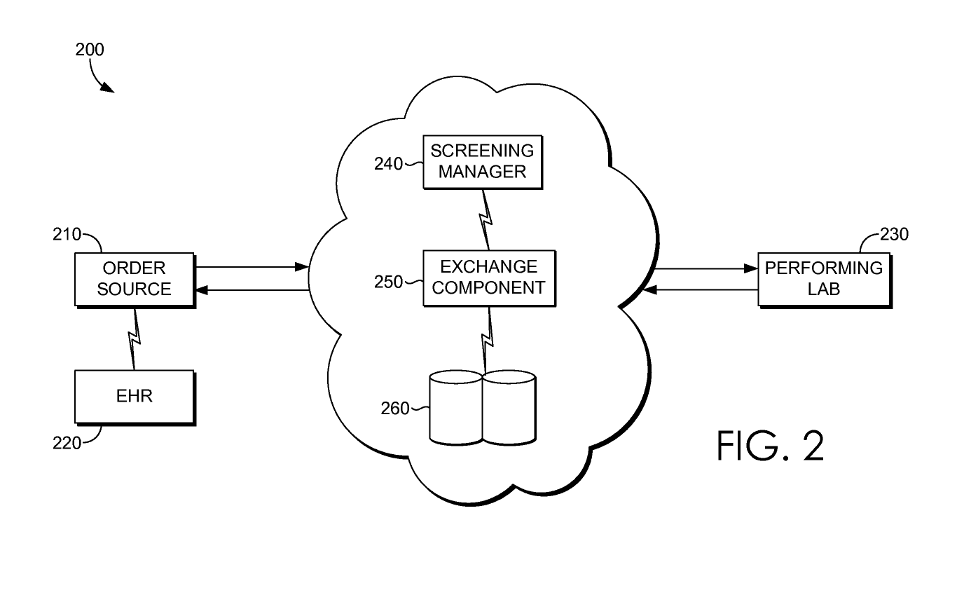

Turning now to FIG. 2, exemplary system architecture 200 suitable for implementing embodiments of the present invention is illustrated. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown the system 200 may include an order source entity 210, an electronic health record (EHR) 220, a performing lab entity 230, a screening manager 240, an exchange component 250, and a database 260.

The order source entity 210 may be associated with any ordering entity (e.g., any entity associated with ordering labs, tests, etc.) and may be, for example, a laboratory, a clinic, a hospital, or other healthcare facility. The order source entity 210 may be configured for, among other things, communicating, receiving, retrieving, etc., newborn screening orders and/or results. The order source entity 210 may be associated with the EHR 220. The EHR 220, while illustrated and referred to as EHR, may be a single patient's EHR or a plurality of EHRs associated with a plurality of patients. In an embodiment, EHR 220 is a database including one or more EHRs.

The performing lab entity 230 may be associated with any performing entity (e.g., any entity associated with performing orders) and may be, for example, a laboratory, a clinic, a hospital, a state office performing newborn screenings, and the like. In an embodiment, the performing lab entity 230 is an entity to perform newborn screenings.

The screening manager 240 may be capable of communicating with a number of different entities, such as the order source entity 210, the EHR 220, and the performing lab entity 230. Additional exemplary entities not shown may include hospitals, state offices, clinician offices, and the like. It should be noted that the entities shown communicating with the screening manager 240 in FIG. 2 are provided by way of example only and are not intended to limit the scope of the present invention in any way. Each entity may have a computing device, such as a remote computer 108 of FIG. 1, for communicating with the screening manager 230. In addition, communication between the screening manager 230 and the various entities may be via one or more networks, which may comprise one or more wide area networks (WANs) and one or more local area networks (LANs), as well as one or more public networks, such as the Internet, and one or more private networks. Further, entities may be able to access the screening manager 230 in a variety of ways within the scope of the present invention. For example, in some embodiments, an entity may have a native clinical computing system, which may be able to communicate with the screening manager 230. In other embodiments, a client application associated with the screening manager 230 may reside on an entity's computing device facilitating communication with the screening manager 230. In further embodiments, communication may simply be a web-based communication, using, for example, a web browser to access the screening manager 230 via the Internet. Any and all such variations are contemplated to be within the scope of embodiments of the present invention.

In an embodiment, the screening manager 240 communicates with entities via the exchange component 250. The exchange component 250 may be configured for, among other things, facilitating communication between entities involved in the newborn screening management. For example, the exchange component 250 may facilitate communication between the screening manager 240 and any other entity such as the order source entity 210 or the performing lab entity 230, between the order source entity 210 and the performing lab entity 230, between the screening manager 240 and the database 260, and any other communication between any component/entity of FIG. 2.

The database 260 may be configured for, among other things, storing newborn screening results, EHRs, etc. The screening manager 240 may act as a central repository for storing newborn screening results. Thus, both the database 260 and screening manager 240 may include newborn screening results. The screening manager 240 may also be configured to store evidence-based knowledge regarding newborn screening such as genetic screening standards of care. An exemplary standard of care is that of the American College of Medical Genetics. Any other evidence based knowledge provider may be used to provide a standard. More than one standard of care may be accessed. In a situation where more than one standard of care is available, the screening manager 240 may utilize a weighting system to identify an appropriate standard of care. The screening manager 240 may also be configured to store evidence-based recommendations based on test results. Family histories may also be input into the screening manager 240 as well as clinician inputs associated with newborn screening results.

The screening manager 240 may also be configured for comparing newborn screening results with one or more other criteria such as family history (of the patient associated with the subject newborn screening result), standards of care, evidence-based recommendations, and the like. Said comparison will aid the screening manager 240 in generating a recommendation to provide for a clinician regarding the newborn screening result. For instance, a newborn screening result may indicate the presence of X marker. Comparison with the standards of care and evidence-based recommendations may indicate that treatment of X marker requires additional secondary testing. The screening manager 240 may then generate a recommendation to provide to a clinician indicating one or more of a recommendation (e.g., secondary testing recommendations based on results), a diagnosis, follow-up instructions (e.g., follow-up with a genetic counselor or metabolic specialist), and the like. The recommendation may also include educational resources relevant to the newborn screening result or an indication of how to access educational resources. For instance, if the newborn screening results indicates presence of marker X, educational resources related to marker X in newborns, treatment of marker X, studies related to marker X, etc., may also be included in the recommendation or associated therewith. Alternatively, an indication of how to access the educational resources, such as a hyperlink, an attached file, etc., may be included in or associated with the recommendation.

The screening manager 240 may also be configured to provide an update to the EHR 220. The update may include the newborn screening result, the diagnosis, the recommendation, the follow-up instruction, or the like. The update may be integrated directly into the patient's EHR such that the newborn screening results are appropriately documented.

The screening manager 240 may also be configured to identify critical results with the newborn screening results. A critical result, as used herein, refers generally to a result that requires a specific action or must be addressed within a predetermined period of time. A critical result alert may be indicated within the recommendation or may be communicated separately.

In application, at least one physical specimen (e.g., a blood sample) may be collected from a newborn at the appropriate collection time. Typically, this occurs at the place of birth (such as a hospital). An electronic order may be created and communicated to the screening manager 240. The order may indicate that a physical specimen has been collected, the time of collection, and that the newborn screening is needed. The order may also identify the newborn from which the physical specimen was collected, date of birth of the newborn, parents/guardians of the newborn, a location to which the newborn screening results should be communicated, place of birth, place of collection, etc.

The physical specimen is then sent to a laboratory to perform newborn screening. Generally, each state maintains at least one state laboratory to perform newborn screening. However, state laboratories typically only provide testing for a specified array of disorders. Accordingly, in some cases, the physical specimen (or multiple physical specimens) may be sent to a plurality of laboratories for testing, including private laboratories. As such, it should be understood that although only a single performing laboratory entity 230 is shown in FIG. 2, multiple laboratories may be employed for a single newborn within the scope of the present invention. In addition, as noted, the performing laboratory entity 230 may represent a state laboratory and/or a private laboratory that provides newborn screening. Further, in some cases, the performing laboratory entity 230 may be a part of the order source entity 210 where the physical specimen was collected.

After receiving the physical specimen, the performing laboratory entity 230 performs the required and/or specified testing, thereby obtaining a number of screening results for the newborn. The performing laboratory entity 230 may then access the screening manager 240 and enter the results. Alternatively, the results may also be written directly to the database 260 through an electronic result message such as Health Level Seven International (HL7). As noted above, in some cases, multiple laboratories may perform testing for a single newborn. In such cases, the results from the various laboratories may be aggregated into a single record for the newborn. If an order was previously created for the newborn screening, for instance, at the order source entity 210, the newborn screening results are associated with the order. If an order was not previously created, a new profile may be created by the performing laboratory entity 230 when entering the newborn screening results.

Upon receiving the results, the screening manager 240 may store the results in database 260. The screening manager 240 may access information stored therein or a separate portal including a variety of criteria to which the newborn screening results should be compared. As previously mentioned, the criteria may include a family history of the patient, evidence-based recommendations for the newborn screening results, standards of care for the newborn screening results, educational resources for the newborn screening results, and the like.

Upon completing the comparison to the available criteria, the screening manager 240 may identify correlations between the newborn screening results and the criteria and generate a recommendation. In other words, the screening manager 240 may identify a result of the newborn screening result and identify treatments, diagnoses, follow-up instructions, education resources, and the like associated with the result. The screening manager 240 may then generate a result including the information identified as correlated or associated with the newborn screening result. Thus, the recommendation may include a diagnosis, a treatment recommendation, a follow-up recommendation, educational resources for both the clinician and patient, and the like.

The screening manager 240 may be configured for identifying when newborn screening results include a critical result, as previously described. When a critical result is identified an indication of the criticality may be included in the generated recommendation or communicated separately.

The screening manager 240 may communicate the newborn screening results and the recommendation to the patient's EHR. This may be accomplished by directly communicating the newborn screening results and the recommendation to the EHR 220 or by communicating the newborn screening results and the recommendation to the EHR 220 via the exchange component 250. The EHR is then updated with the results and recommendation.

Along with updating the EHR, the screening manager 240 may communicate a notification of availability to the appropriate recipients. Alternatively, the newborn screening results and recommendation may be directly communicated to the appropriate recipients rather than an indication of availability. Such communication (either the indication of availability or the actual results/recommendation) may be communicated via any means desired to deliver results or availability indications including, but not limited to, e-mail messages, text messages, a client application, or a recipient's native clinical computing system.

By utilizing a centralized decision support system such as screening manager 240, consistency may be provided to an organization as well as aiding in the development of clinicians with the practice relating to newborn screening results.

In an embodiment, an interface may be provided that provides the newborn screening results and recommendations to the clinicians. Critical results may be prioritized and identified appropriately such as, for example, with an icon or indicator used to indicate critical results. The interface may organize results/recommendations in any manner deemed appropriate to a user, client, administrator of system, etc. For instance, the results/recommendations may be organized such that the critical results are reviewed first. Alternatively, the results/recommendations may be organized according to collection date, date results were received, etc.

The interface may also provide a means for a clinician to decline a recommendation. For instance, if a recommendation is generated indicating secondary testing is needed but a clinician is not, for one reason or another, recommending that to the patient, the clinician may simply “override” the recommendation. The interface may provide a notes area for a clinician to document why a recommendation was followed or otherwise.

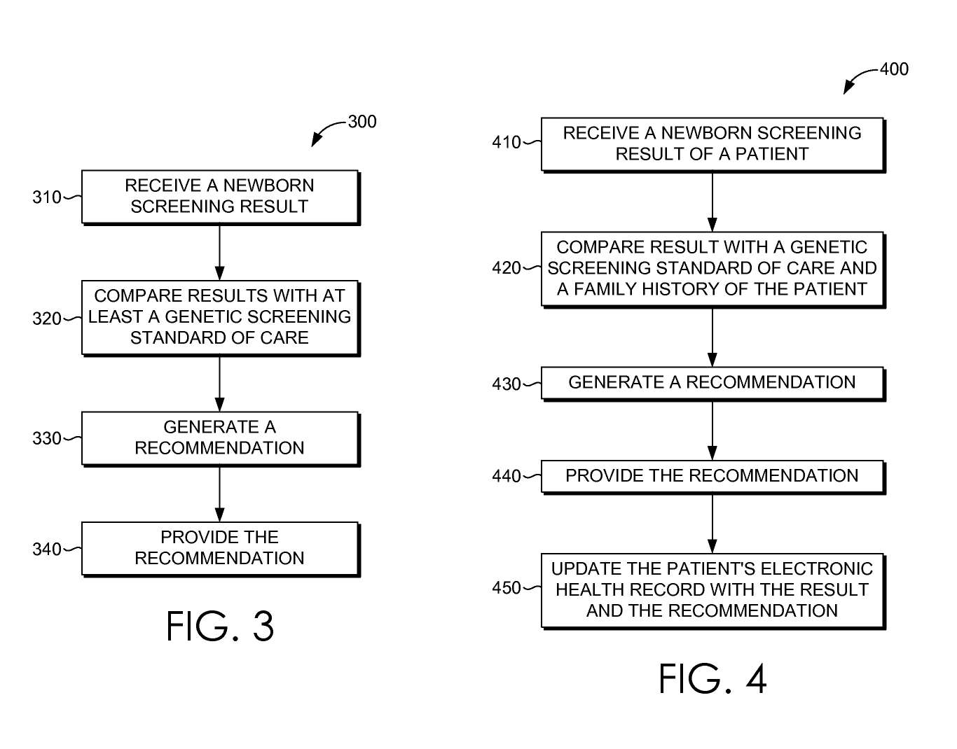

Referring now to FIG. 3, a flow diagram is provided illustrating a method 300 for managing newborn screening results, in accordance with an embodiment of the present invention. Initially, at block 310 a newborn screening result is received. The newborn screening result is then compared with at least a genetic screening standard of care at block 320. Based on the comparison, a recommendation is generated at block 330. The recommendation is then provided to, for example, the ordering clinician at block 340.

Turning to FIG. 4, a flow diagram is provided illustrating a method 400 for managing newborn screening results, in accordance with an embodiment of the present invention. Initially, at block 410, a newborn screening result for a patient is received. The newborn screening result is compared to a genetic screening standard of care and the patient's family history at block 420. A recommendation is generated at block 430 and provided to a clinician at block 440. The patient's EHR is updated with both the newborn screening results and the recommendation at block 450.

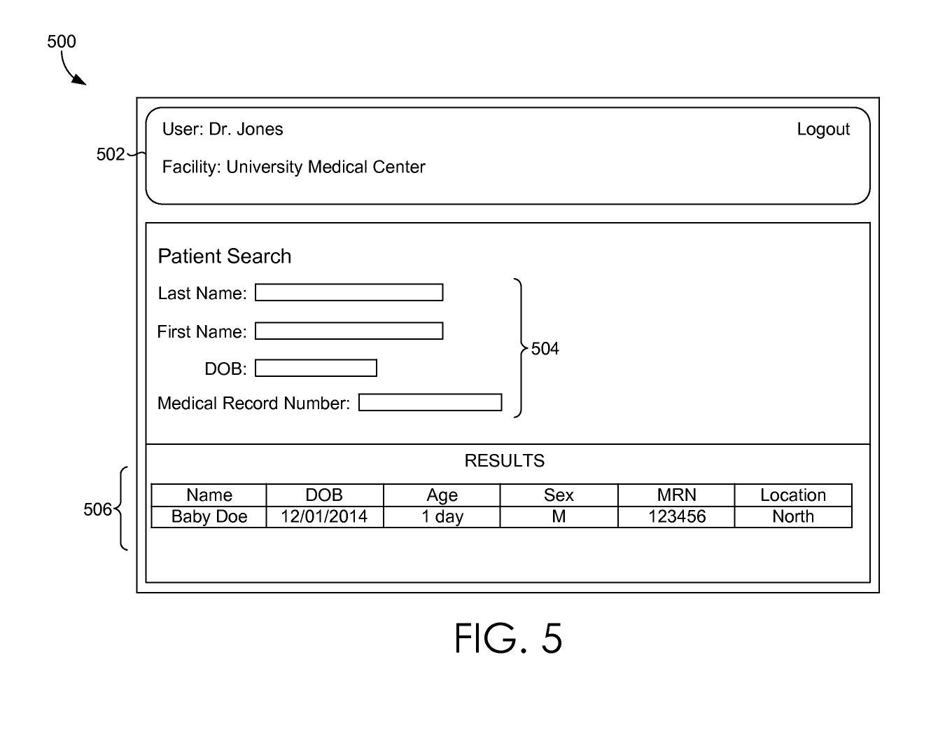

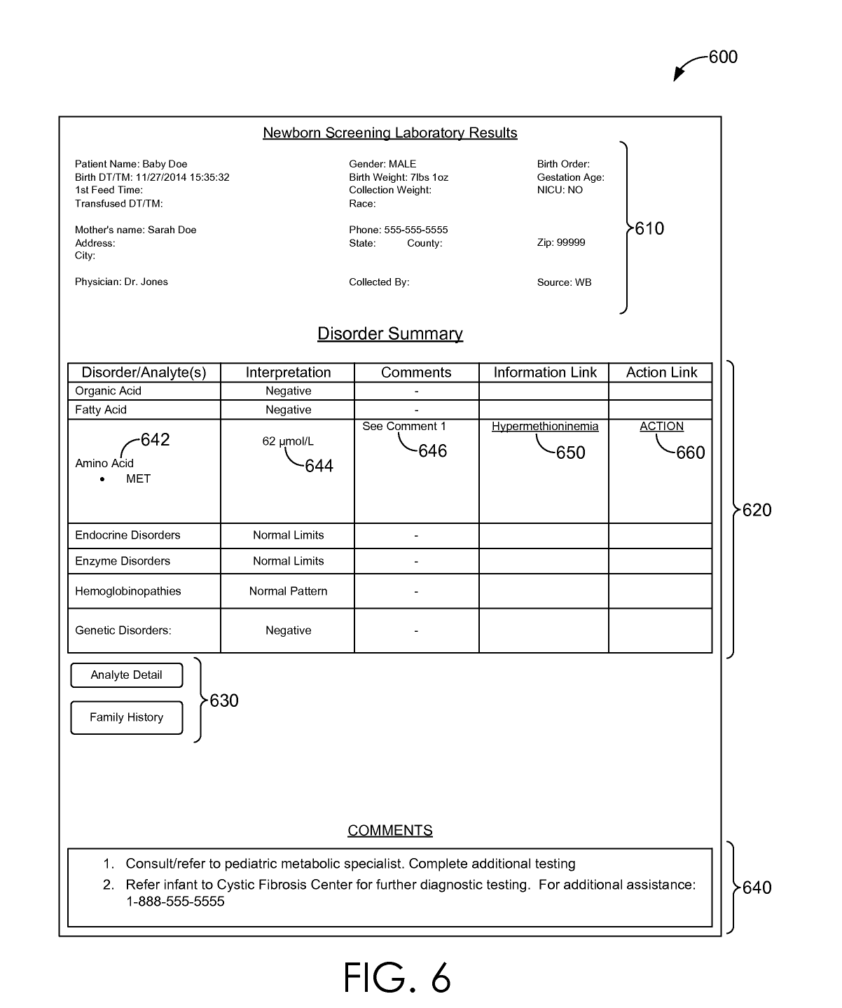

Turning now to FIG. 5, an exemplary graphical user interface (GUI) is provided for use in embodiments of the present invention. FIG. 5 provides a GUI 500 for accessing a newborn screening decision support system. The GUI 500 includes a provider information area 502 that may include a provider name, provider location (e.g., facility), an employee identification number, a user name, etc. The GUI 500 also includes a patient identification area 504 where a clinician/user may search for a patient. Various searchable criteria may be included in the patient identification area 504 such as a patient name, date of birth, medical record number, and the like. Once information has been entered into the patient identification area 504, one or more results may be provided in a results area 506. As illustrated, the results area 506 includes a result for Baby Doe that corresponds to one or more search criteria entered in the patient identification area 504. The results of results area 506 may be selectable such that selection thereof navigates a user to a patient results GUI 600 as illustrated in FIG. 6.

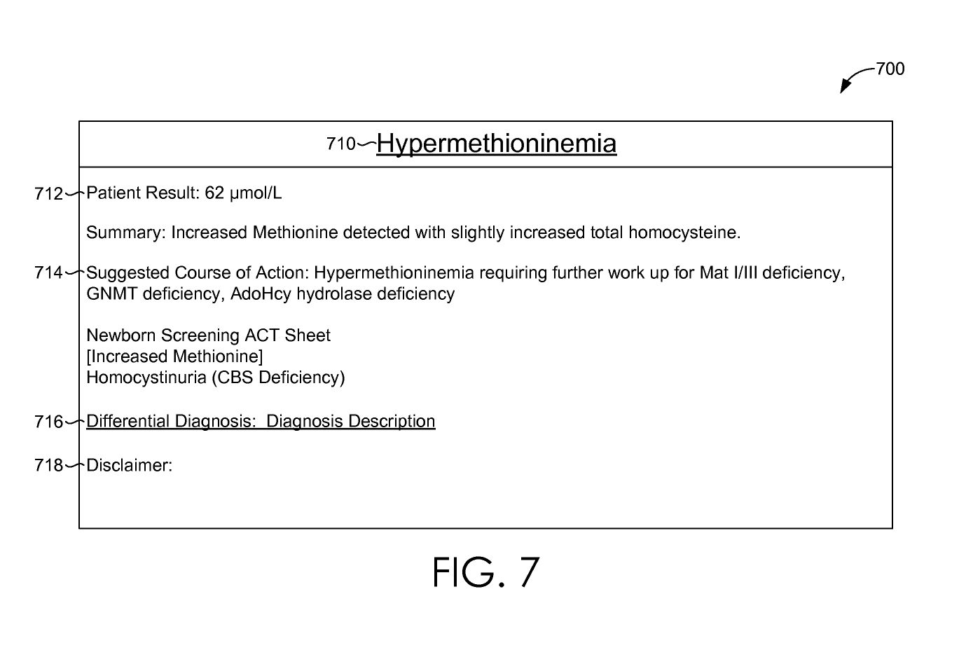

FIG. 6 provides a detailed view of a patient results page 600 that includes a patient identification region 610. The patient identification region 610 may include identifying information for the selected patient (from FIG. 5) that is more detailed than the information used to search for a patient. For instance, the patient identification region 610 may include a phone number, an address, contact information, parent's identification, feeding information, time of birth, gender, birth weight, race, birth order, gestational age, or the like. GUI 600 also provides a summary area 620 that includes a summary of newborn screening results. Summary area 620 illustrates the summary as identifying one or more disorders or analytes but the summary area 620 may be organized in any other manner related to newborn screening results such as by test name (rather than disorders), etc. Summary area 620 includes a first indicator 642 indicating a disorder/analyte. An interpretation indicator 644 may be provided for each disorder/analyte indicated. Here, interpretation indicator 644 is a level. A comment indicator 646 may be provided for each result and, as illustrated, may provide a reference to a comments area 640 that provides detailed comments. Information indicator 650 may be provided for each result and may be selectable such that selection thereof navigates a user to an information summary 700 as illustrated in FIG. 7. The information summary 700 may include a variety of information. The illustrative information summary 700 indicates a title/disorder with header 710. A result may be reproduced an indicated in a results area 712. A summary of the disorder may be provided as well as clinical considerations, diagnostic evaluation results, a description of the condition, etc. A suggested course of action may be listed in an action area 714 as well as a diagnosis indicated in diagnosis area 716. Finally, a disclaimer area 718 may be provided that advises the information is merely an educational resource for clinicians and clinicians should apply his/her own professional judgment to clinical situations.

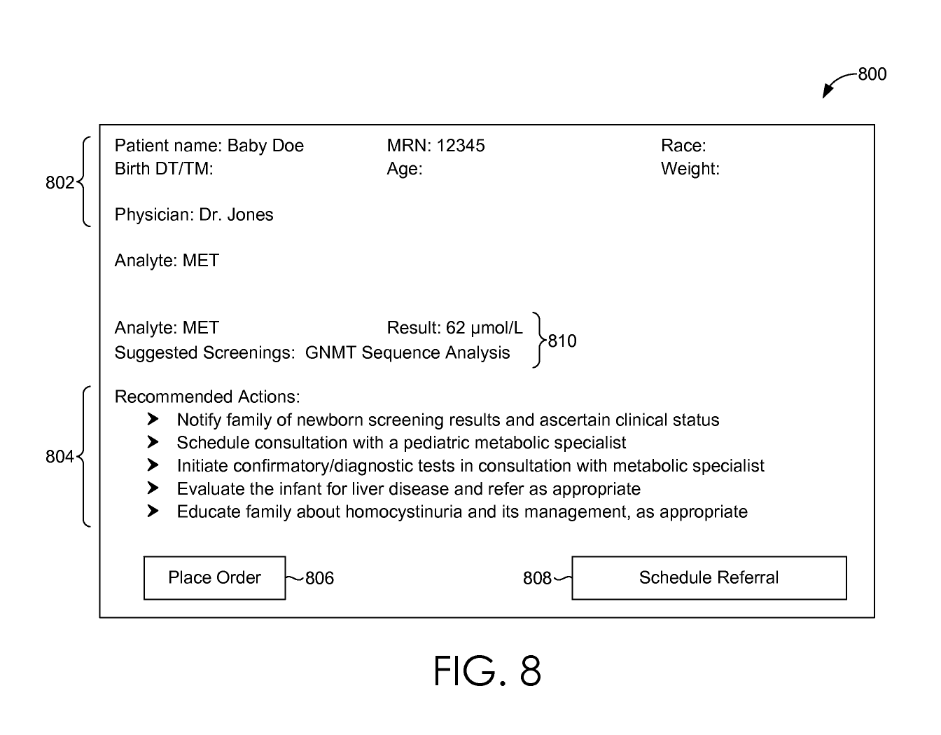

Returning to FIG. 6, an action indicator 660 may be provided that is selectable such that selection thereof navigates a user to a view where action may be taken with respect to the result (e.g., order follow-up tests, scheduling a follow-up appointment, etc.). An exemplary action view 800 is provided in FIG. 8. Thus, in an embodiment, selection of the action indicator 660 navigates a user to action view 800. An action view 800 may include information including patient and/or clinician information displayed in information area 802, newborn screening results displayed in result area 810, and a list of recommended actions displayed in action area 804. The recommended actions may be identified by comparison of a variety of factors, as described hereinabove. From the action view 800, specific actions may be executed and represented by action initiating icons. Exemplary action initiating icons include order entry icon 806 and schedule referral icon 808.

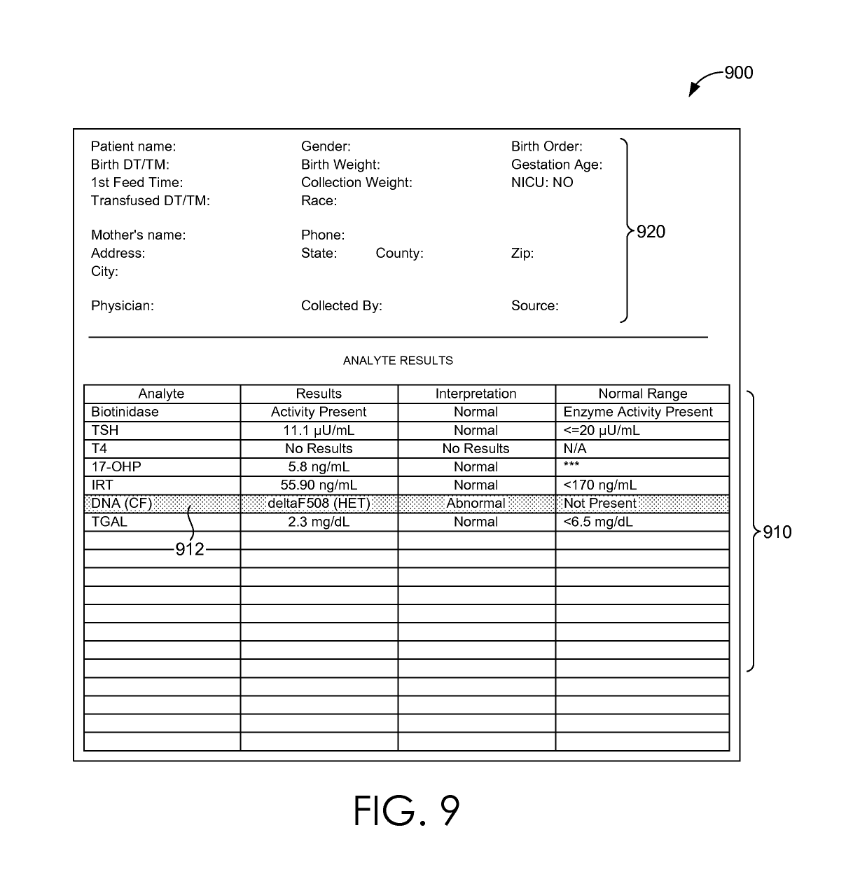

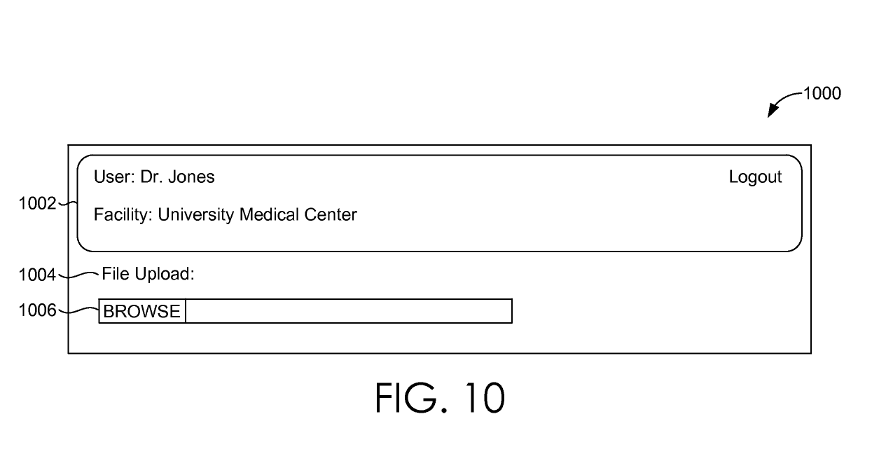

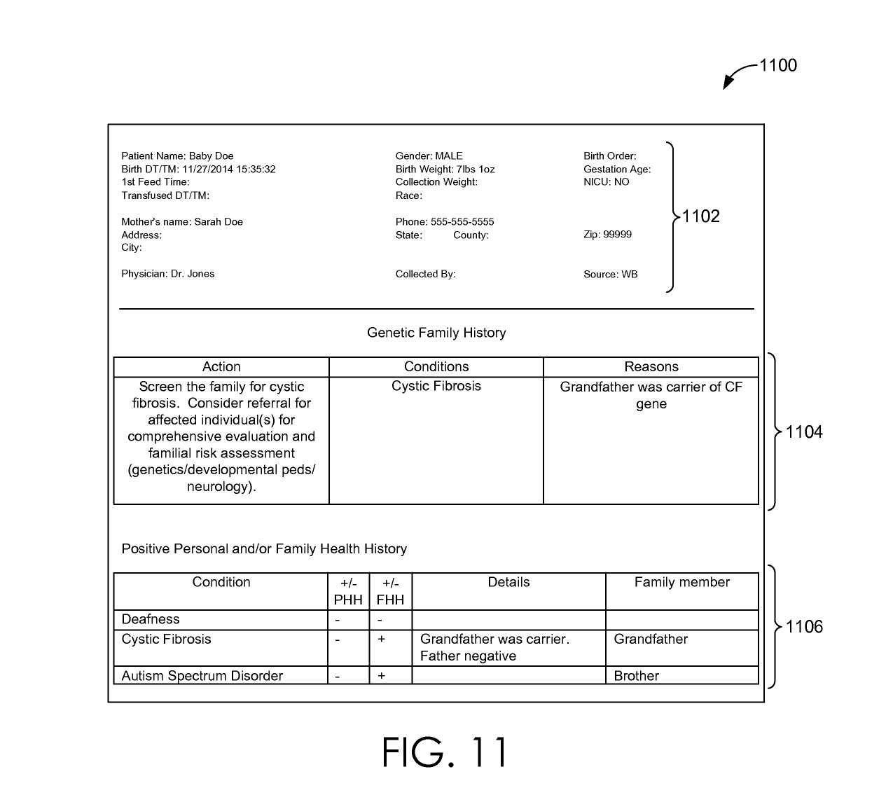

Detailed options may be provided in FIG. 6 such as analyte detail icon and family history icon represented in detailed icon area 630. There may also be a specific icon to navigate to the action view 800 such as, for example, an action view icon. Each detailed option icon may be selectable. For instance, selection of the analyte detail icon may navigate a user to a detailed results interface 900 provided in FIG. 9. FIG. 9 includes a patient/clinician information area 920 and a results area 910. The results may include all results from newborn screenings for the patient. Abnormal results may be highlighted such as result 912 so that a user is quickly drawn to the abnormal result. Additionally, selection of the family history detail icon may navigate a user to a family history interface 1100 as provided in FIG. 11. FIG. 11 provides an information area 1102, a genetic family history area 1104, and a positive family history area 1106. The information area 1102 may include information identifying a patient, a clinician, or the like. The genetic family history area 1104 may include a family history for the patient and particular disorders to monitor. For instance, the exemplary family history interface 1100 provides that Cystic Fibrosis may be an issue as the grandfather was a carrier of the gene. The genetic family history area 1104 may also provide actions recommended for the conditions. The positive family history area 1106 may include positive results for one or more conditions.

Turning now to FIG. 10, a loading interface 1000 is provided illustrating an interface to use in order to upload data into the clinical decision support repository. The loading interface 1000 may include an identification area 1002 (identifying a user/clinician), a file upload indicator area 1004 indicating a file to be uploaded upon selection, and a file search area 1006 allowing a user to search for files/data to upload. In an embodiment, evidence based knowledge is loaded into the clinical decision support repository via the loading interface 1000.

The present invention has been described in relation to particular embodiments, which are intended in all respects to be illustrative rather than restrictive. Further, the present invention is not limited to these embodiments, but variations and modifications may be made without departing from the scope of the present invention.

What is claimed is:

1. A computerized method, carried out by at least one server having one or more processors, the method comprising:
receiving a newborn screening result for a patient;
comparing the newborn screening result with at least a genetic screening standard of care;
based on the comparison, generating a recommendation; and
providing the recommendation.

2. The method of claim 1, wherein one or more educational resources are provided along with the recommendation.

3. The method of claim 1, wherein the recommendations includes instructions for a follow-up care.

4. The method of claim 1, wherein the genetic screening standard of care is a guideline from the American College of Medical Genetics.

5. The method of claim 1, further comprising comparing the newborn screening result with a family history of the patient.

6. The method of claim 1, further comprising evaluating one or more evidence based recommendations.

7. The method of claim 1, wherein one or more clinician notes are included with the newborn screening result received.

8. The method of claim 1, further comprising generating an alert for the newborn screening result upon identifying the newborn screening result includes a critical result.

9. The method of claim 8, wherein the critical result is a result that requires action within a predetermined period of time.

10. A system for managing newborn screening results, the system comprising:
one or more processors; and
one or more computer storage media storing computer-useable instructions that, when used by the one or more processors, causes the one or more processors to:
receive a newborn screening result for a patient;
compare the newborn screening result with at least a genetic screening standard of care;
based on the comparison, generate a recommendation; and
provide the recommendation.

11. The system of claim 10, wherein the one or more processors compare the newborn screening result with a family history of the patient.

12. The system of claim 10, wherein the genetic screening standard of care is a guideline from the American College of Medical Genetics.

13. The system of claim 10, wherein the one or more processors evaluates one or more evidence based recommendations.

14. The system of claim 10, wherein the one or more processors generate an alert for the newborn screening result upon identifying the newborn screening result includes a critical result.

15. The system of claim 14, wherein the critical result is a result that requires action within a predetermined period of time.

16. One or more computer storage media having computer-executable instructions embodied thereon that, when executed, facilitate a method of managing newborn screening results, the method comprising:
receiving an order for a newborn screening of a patient;
receiving a newborn screening result for the patient;
comparing the newborn screening result with at least a genetic screening standard of care and a family history of the patient;
based on the comparison, generating a recommendation including follow-up instructions;
providing the recommendation; and
updating the patient's electronic health record with the newborn screening result and the recommendation.

17. The media of claim 16, wherein the genetic screening standard of care is a guideline from the American College of Medical Genetics.

18. The media of claim 16, further comprising generating an alert for the newborn screening result upon identifying the newborn screening result includes a critical result.

19. The method of claim 18, wherein the critical result is a result that requires action within a predetermined period of time.

20. The media of claim 16, further comprising providing a suggested diagnosis for the patient.
